(19) United States
(12) Patent Application Publication
(10) Pub. No.: US 2003/0227546 A1
(43) Pub. Date: Dec. 11, 2003

(54) Viewing arrangement

(76) Inventors: Thomas W. Hilborn, West Hills, CA (US); Jose Rafael Venegas, Reseda, CA (US)

Correspondence Address: DON B. FINKELSTEIN, ESQ., LAW OFFICES OF DON FINKELSTEIN, 3858 CARSON STREET, SUITE 216, TORRANCE, CA, 90503, US

(21) Appl. No.: 10/164,521

(22) Filed: Jun. 6, 2002

(51) Int. Cl. H04N 7/18

(52) U.S. Cl. 348/148

(57) ABSTRACT

An arrangement for providing the operator or driver of a vehicle a real time view of the scene to the rear of the vehicle

### BACKGROUND OF THE INVENTION

1. Field of the Invention

This invention relates to the viewing art and more particularly to an improved arrangement for providing the operator or driver of a vehicle with a real time view of the structure or obstruction, or lack of structure or obstruction, to the rear of the vehicle and is particularly useful during dark or light degraded conditions when direct viewing of such structures is impaired.

2. Description of the Prior Art

During the driving of a vehicle it is frequently desirable to view the scene to the rear of the vehicle. During normal daylight conditions, the driver of the vehicle can generally use the rear view mirrors of the vehicle or by rotating his/her head, directly see any structure behind the vehicle. During driving, such structure may be, for example, an approaching vehicle. While backing the vehicle during a parking or leaving a parking place, particularly at night or when the visibility is impaired, the structure behind the vehicle, which the driver seeks to avoid, may not be clearly seen or recognized.

While backup lights installed on many vehicles have attempted to provide illumination of such structures behind the vehicle, the viewing of the structures still requires the use of the rear view mirrors or turning the head in an attempt to see clearly the position of such structure so that impact therewith may be avoided. “Blind spots” in the rear view mirrors field of view as well as limitations on the field of view obtained directly by turning the head to face the rear of the vehicle has often not provided a clear views of the structures to be avoided due to blocking by portions of the vehicle itself such as head rests, small rear windows and the like.

Thus, there has long been a need for an arrangement in a vehicle that would provide the driver of the vehicle with an unobstructed visual presentation to the rear of the vehicle during even visually impaired driving conditions.

One attempt to solve this problem has been the use of a device employing acoustic sensors which transmit a modulated beam signal. When the signal strikes a solid object directly, it bounces back to a receiver which activates a microprocessor which is controlled by specific software. The software causes a continuous calculation of the separation between the vehicle and the object to the rear of the vehicle. A voice synthesizer is utilized and provides to the driver of the vehicle with a synthesized voice specifying the distance to the object. However, since most information is received by humans through the visual sense rather than the auditory sense, the audio signal provided by such device does not give to the driver the detailed information that a visual presentation of the object can provide.

### SUMMARY OF THE INVENTION

Accordingly, it is an object of the present invention to provide an improved rear view viewing arrangement for automobiles.

It is another object of the present invention to provide an improved rear view viewing arrangement for automobiles particularly att night or other visually impaired conditions.

It is yet another object of the present invention to provide an improved rear view viewing arrangement for automobiles which incorporates a visual display for the operator of the vehicle of the scene behind the vehicle.

It is yet another object of the present invention to provide an improved rear view viewing arrangement for automobiles which incorporates a visual display in real time for the operator of the vehicle of the scene behind the vehicle.

The above and other objects of the present invention are achieved, according to a first preferred embodiment thereof, by utilizing a viewing device in cooperative engagement with one or more of the rear light sources on a vehicle for providing a real time visual image of the scene behind the vehicle such as during the daylight, at night or in other visually impaired conditions. As utilized herein, the viewing device may be a digital camera, a fiber optic cable arrangement, a video camera, or other viewing devices capable of providing a real time imaging of the scene immediately behind the vehicle. The rear light sources may be any one or more than one of the lights incorporated on the back of the vehicle and may be the rear lights, lower rear brake lights, upper rear brake light, back up lights or any other light source incorporated on the back of the vehicle. The rear light source, or sources, emits light comprising electromagnetic radiation in the visible portion of the electromagnetic spectrum which illuminates at least a portion of the scene behind the vehicle. For the condition wherein there is structure or obstruction behind the vehicle which is within range of the light emitted by the light source, such emitted light is reflected from the structure or object back towards the vehicle. The viewing device is located in reflected light receiving relationship to receive the light reflected from the object or structure that is behind the vehicle. The reflected light may be the normal daylight, artificial light from a source other than the vehicle, or the light from one or more of the rear lights on the vehicle. The viewing device generates an information signal defining the scene to the rear of the vehicle as indicated by the light reflected therefrom.

The light viewing device is operatively connected to a display source. The display device may be, for example, a cathode ray tube such as is conventionally utilized in computer monitors, light emitting diode display, TFT display or the like that is compatible with the information signal generated by the viewing device. The display source converts the information signal into a visually perceptible display in regions within visual acquisition by the operator of the vehicle.

In the preferred embodiments of the present invention, the viewing device is associated with one or more of the rear lights on the vehicle since the wiring harness of the vehicle provides a convenient structure in the vehicle to provide any required electrical energy to the viewing device.

In this first preferred embodiment, the camera is located adjacent the upper brake light. Such location is often preferred since the upper brake light is located in regions near the top of the vehicle or at least at a greater elevation from the road on which the vehicle is located than the back up lights, the rear lights and the lower rear brake lights. That is, on SUV type vehicles or van type vehicle the upper brake light is often close to the top of the vehicle. In some vehicles which incorporate a “wing” on the trunk lid, the upper brake light is often incorporated into the “wing”. Thus, as utilized herein, the term “upper brake light” refers to the brake light above the tail lights and lower brake lights, regardless of where on the vehicle it may be located. Such a position provides a maximum field of view, which is a desired object of a preferred embodiment of the present invention. There are generally blind spots in the various rear view mirrors and/or by direct viewing by the operator of the vehicle due to obstruction by structures in the vehicle or the limited size of the rear window of the vehicle. Further, this location of the viewing device also minimizes the “blinding” effect which might be caused by the headlights of vehicles approaching from the rear of the vehicle. For example, at night or in darkened conditions, the operator of the vehicle need only tap the brakes of the vehicle, which turns on the upper and lower brake lights, and watch the display source in order to see, on a real time basis, the object or structure to the back of the vehicle.

The viewing device may be provided with a fixed lens or, if desired, a variable lens to provide wider fields of view, close up, or the like, as is well known in the camera/lens art. If a variable lens is provided on the viewing device, the lens is remotely operated by the operator of the vehicle. Either or both the viewing device and the display source may be provided with shut off means such a a power switch to terminate the operation thereof when it is not required. For example, if desired, the viewing device may be operated together with the brake lights so that when the brake lights are off the viewing device is turned off. Since many vehicles are now being provided with a display source accessible by the operator of the vehicle for use in GPS positioning, map directions and the like, a selector switch may be provided so that the displkauy source shows the desired view.

In other embodiments of the present invention, the viewing device may be located in proximity to the rear lights, the back up lights or the lower brake lights of the vehicle, depending upon the requirements of particular applications. For example, in many pickup trucks, the upper rear brake light is often located at the top of the back of the cab and thus the bed of the pickup blocks a clear view of any structure to the rear of the vehicle. In such embodiments, it is preferred to place the viewing device at the back of the bed of the pickup to provide the most comprehensive view of any structure to the rear of the vehicle. As utilized herein, the structure to the rear of the vehicle refers to any object, whether a wall, post, fence, other vehicle or the like that is located to the rear of the vehicle.

Further, in other embodiments of the present invention more than one viewing device may be installed on the vehicle and in such multiple viewing device applications the viewing devices may be oriented to provide different views to the rear of the vehicle. For example, one viewing device may be oriented to provide a view directly to the rear of the vehicle and centered on the back of the vehicle. Another viewing device may be positioned to provide a view of the scene of oncoming traffic from the rear of the vehicle.

By placing the display source in the regions adjacent the driver of the vehicle, the drivers head need not be turned in order to see the scene to the rear of the vehicle during back up of the vehicle or otherwise.

As is well known, the design, shape, orientation, location, combination, separation, configuration, spacing, integration and the like of the various lights on the rear of a vehicle been only limited by the imagination of the automotive designers and thus are virtually infinite in number.

### BRIEF DESCRIPTION OF THE DRAWING

The above, and other objects of the present invention may be more fully understood from the following detailed description taken together with the accompanying drawing wherein similar reference characters refer to similar elements throughout and in which:

FIG. 1 is a schematic representation of the rear of a conventional vehicle showing the location of the various light sources usually included thereon and the viewing device mounted adjacent to and above the upper brake light;

FIG. 1A is a schematic representation of the preferred embodiment of the present invention of FIG. 1 showing a top plan view thereof illustrating the vehicle and the structure or object to the rear of the vehicle which is viewed by the viewing device;

FIG. 1B is a schematic representation of the preferred embodiment of the present invention of FIG. 1 showing a side elevational view thereof illustrating the vehicle and structure or object to the rear of the vehicle which is viewed by the viewing device;

FIG. 2 is a schematic representation of a preferred embodiment of the present invention showing the viewing devise in proximity to and below the upper brake light;

FIG. 3 is a schematic representation of a preferred embodiment of the present invention showing the viewing device in proximity to and positioned laterally of the upper brake light;

FIG. 4 is a schematic representation of a preferred embodiment of the present invention showing the viewing device incorporated into the upper brake light;

FIG. 5 is a schematic representation of a preferred embodiment of the present invention showing the viewing device intermediate the left and right rear brake, backup and tail lights;

FIG. 6 is a schematic representation of a preferred embodiment of the present invention showing the viewing device in proximity to the right rear brake light;

FIG. 7 is a schematic representation of a preferred embodiment of the present invention showing the viewing device in proximity to the right rear back up light;

FIG. 8 is a schematic representation of a preferred embodiment of the present invention showing the viewing device located in proximity to the rear, or tail, light of the vehicle;

FIG. 9 is a schematic representation of the system of the present invention showing the relationship of the viewing device, light source and display source;

FIG. 10 illustrates an exploded view of the installation of the viewing device of the present intention in an upper brake light assembly;

FIG. 11 illustrates an exploded view of the installation of the viewing device as incorporated in an upper brake light as installed on an SUV type vehicle;

FIGS. 12A, 12B and 12C illustrate pictorial arrangements of the viewing device according to the present invention as installed in various arrangements in the upper brake light assembly;

FIG. 13 illustrates an exploded view of the viewing device according to the principles of the present invention as incorporated into a side mounted combination rear light assembly;

FIG. 14 illustrates a pictorial view of the back of a pickup type vehicle having a combination type rear light assembly including a viewing device of the present invention; and

FIG. 15 is a pictorial view of the back of and SUV of van type vehicle having multiple viewing devices installed on the various rear lights thereof.

### DESCRIPTION OF THE PREFERRED EMBODIMENTS

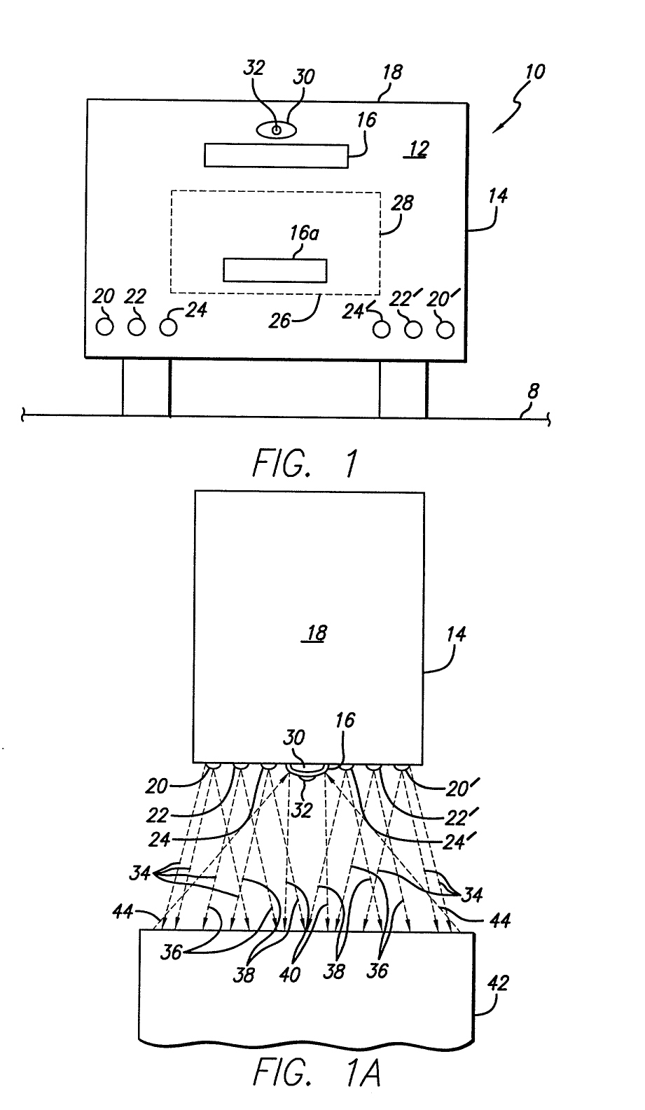

Referring now to the drawing, there is illustrated in FIGS. 1, 1A and 1B a preferred embodiment of the present invention, generally designated 10 illustrating the back 12 of a conventional vehicle 14. The description of the present invention is presented herein in schematic representation since the design of the vehicles and the various components of the vehicles are virtually unlimited in configuration. The configuration of the vehicle and the components thereof are generally made to be as aesthetically appealing as the design constraints imposed by law, size, and the like allow. The present invention may be adapted to virtually any design configuration.

In the general configuration of present motor vehicles as shown on FIG. 1, the vehicle 14 rests on the ground 8 and is provided with a plurality of light sources on the back 12 of the vehicle 14. One of the light sources is the upper brake light 16 located in regions near the top 18 of the vehicle 14. Such upper brake light 16 has been mandated by law in the United States for all presently manufactured vehicles. The vehicle 14 is also generally provided with additional light sources on the rear such as one or more lower brake lights indicated on FIG. 1 at 20 and 20′ and the vehicle 14 may also be provided with one or more rear or tail lights 22 and 22′ as well as one or more back up lights 24 and 24′. The lower brake lights 20 and 20′ are located much closer to the ground 8 than the upper brake light 16. All of the light sources 16, 20, 20′, 22, 22′ 24 and 24′ emit light comprising electromagnetic radiation in the visible portion of the electromagnetic spectrum when they are suitable energized as, for example, by electrical power. The light emitted by these light sources is directed to the rear of the vehicle. The upper brake light 16 and the lower brake lights 20 and 20′ operate at the same time and are energized when the brake pedal (not shown) of the vehicle 14 is depressed. The tail lights 22 and 22′ are energized when the driving or main lights of the vehicle are turned on. The back up lights 24 and 24′ are energized when the vehicle 14 is placed in reverse. In many vehicle designs, the lights 20, 22 and 24 and 20′, 22′ and 24′ are incorporated into a single assembly but still have separate light sources for each function.

The schematic depiction of the vehicle 14 is a somewhat schematic representation of an SUV or a van type vehicle. Thus, the upper brake light 16 is comparatively close to the top 18 of the vehicle 14 or in other applications the upper brake light is located on the wing, at the “crease” of the trunk lid or in other desired locations. In many other sedan or coupe type vehicles the upper brake light 16a is located at the lower edge 26 of a rear view window 28 shown in dotted lines. Even though not as close to the top 18 of the vehicle 14, the upper brake light 16a is still further from the ground 8 than the lower brake lights 20, 20′, tail lights 22, 22′ and back up lights 24, 24′ and thus illuminate a scene to the rear of the vehicle 14 that extends from the ground 8 to regions higher from the ground 8.

In the first preferred embodiment 10 of the present invention, a viewing device 30 is positioned in regions adjacent the upper brake light 16 of the vehicle 14 wherever the upper brake light may be located on the vehicle.. The viewing device 30 may be any type of viewing device that allows a real time transmission of the scene that is viewed. Thus, the viewing device 30 may be a digital camera, a TV camera, a fiber optic cable arrangement, or the like. As such, the viewing device 30 generally incorporates a lens 32 through which the viewed scene is transmitted to regions remote from the viewing device 30, as described below. The viewing device 30 may be incorporated with as much sophistication as desired such as with a lens that can pan, have various focal distances and the like, all remotely operated by the operator of the vehicle 14. The viewing device 30 and the lens 32 may be of conventional design well known in the art. The present state of the art of miniature video cameras provides them as small as about ¾ inch square in cross section and on the order of two to three inches long. FIGS. 1A and 1B show the embodiment 10 of the present invention in a top plan schematic representation and side elevational view presentation, respectively, illustrating the light paths of the various light emitting devices of the present invention and the viewing device 30. As shown, when all of the rear lights of the vehicle 14 are activated, the rear brake lights 20 and 20′ emit light indicated symbolically by the arrows 34, the rear tail lights 22 emit light indicated symbolically by the arrows 36 and the rear back up lights emit light indicated symbolically by the arrows 38. The upper brake light 16 emits light indicated symbolically by the arrows 40. When the light emitted by the rear lights of the vehicles as illustrated in FIG. 1A illuminates a structure or obstruction 42 to the rear of the vehicle 14, a certain amount of light is reflected back from the structure or obstruction 42 into the lense 32 of the viewing device 30 as indicated by the arrows 44. The various arrows 34, 36, 38 and 40 are symbolic representations only and do not define the full range of light emission or reflection. The reflected light indicated by the arrows 44 provides to the viewing device 30 a real time view of the structure or obstruction 42.

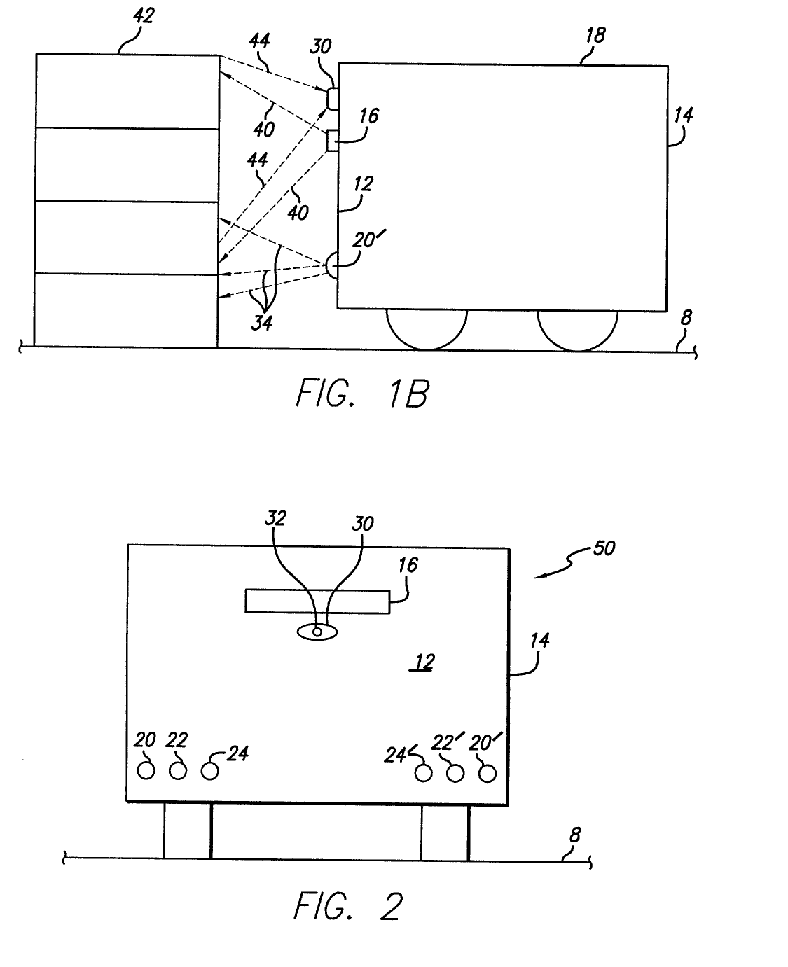

FIG. 2 illustrates an embodiment 50 of the present invention similar to the embodiment 10 except that the viewing device 30 is positioned adjacent to and below the upper brake light 16. In some applications such an arrangement may be preferred.

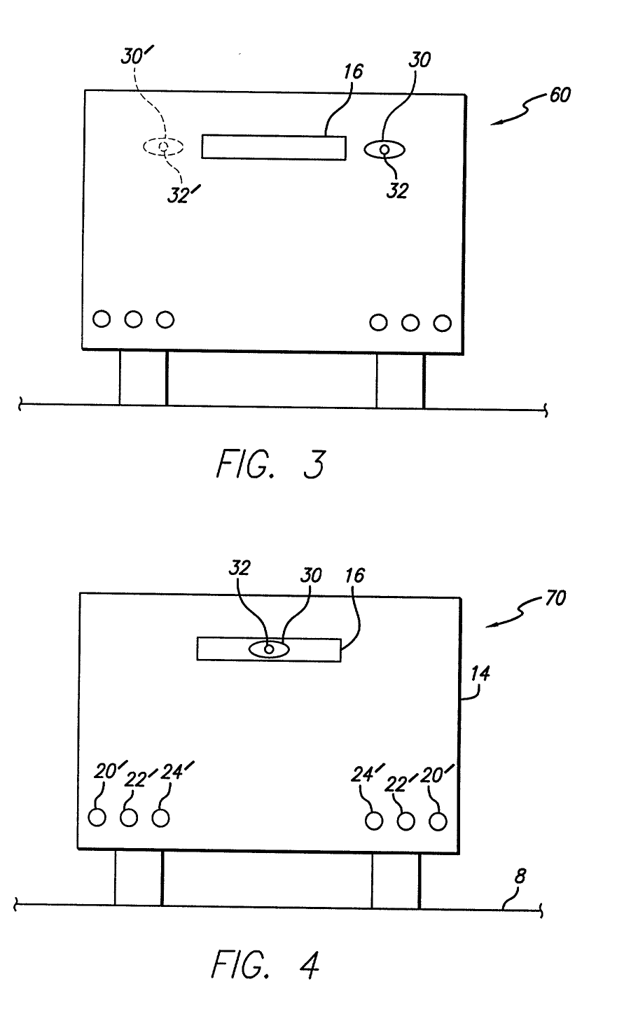

Similarly, FIG. 3 illustrates an embodiment 60 of the present invention similar to the embodiment 10 except that the viewing device 30 is positioned adjacent to and laterally of the upper brake light 16. As shown on FIG. 3, the viewing device is illustrated to the right of the upper brake light 16. However, it may also be positioned to the lft of the upper brake light 16 as illustrated by the dashed line showing at 30′. If desired in some applications, the second viewing device 30′; with a lens 32′ may be incorporated on the same vehicle 14 and thus provide two separate viewing devices whose visually detected images may be viewed by the operator of the vehicle 14.

In some applications it may be desirable to incorporate the viewing device 30 into the upper brake light assembly 16. FIG. 4 illustrates in schematic form an embodiment 70 of the present invention in which the viewing device 30 with the lens 32 is incorporated into the upper brake light 16. Since the design of the various components of a vehicle are often selected to be as ornamentally pleasing as possible within the constraints of the physical requirements, any of the embodiments of the present invention may be made as ornamentally attractive as desired. One such ornamental configuration of a viewing device incorporated into an upper brake light of a vehicle is shown in our co-pending design patent application Ser. No. 29/155,478, filed Feb. 12, 2002. However, many other ornamental configurations for the combination of a viewing device incorporated into an upper brake light may be made as desired.

The embodiments 10, 50, 60 and 70 the viewing device 30 is adjacent to or incorporated into the upper brake light 16. However, in certain vehicles, this arrangement may not provide the optimal view of the structure or obstruction to the rear of the vehicle. For example, pick up trucks, particularly those with extended beds, tend to have the view to the rear of the vehicle as viewed from the upper brake light, which is incorporated at the rear of the cab near the top of the vehicle, partially or substantially blocked by the tail gate and/or bed. Similarly, if a sedan or coupe type vehicle has an extended trunk, the view to the rear of the vehicle from regions adjacent the upper brake light may be partially obscured. Therefore, in such applications, it may be desirable to incorporate the viewing device in regions adjacent or with reflective light receiving relationship to one or more of the brake lights 20, 20′, rear or tail lights 22, 22′ or back up lights 24, 24′ of the vehicle.

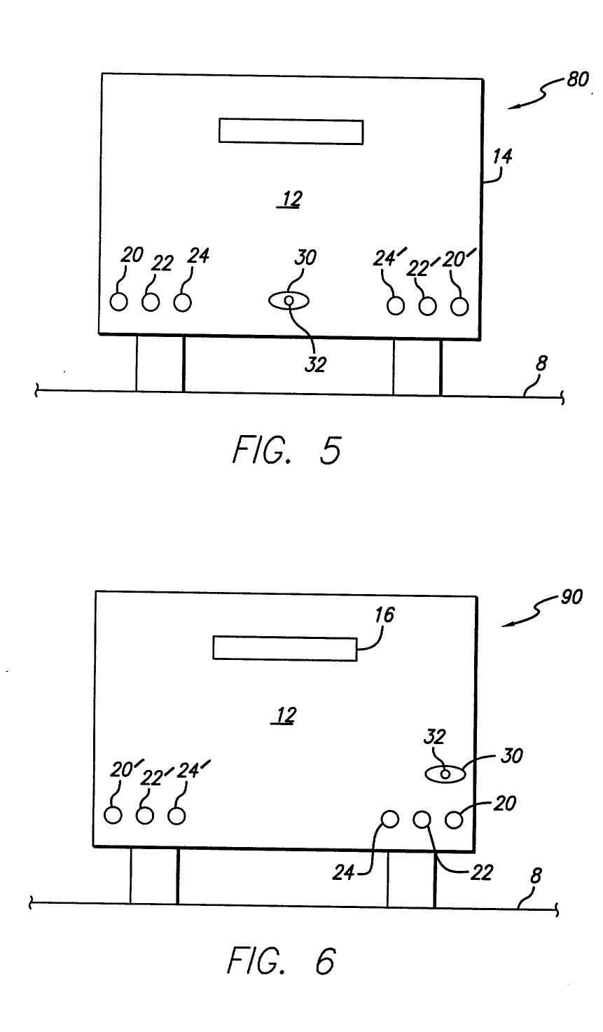

FIG. 5 illustrates in schematic form an embodiment 80 of the present invention in which the viewing device 30 with lens 32 is positioned approximately in the center of the back 12 of the vehicle 14 intermediate the brake lights 20, 20′, rear or tail lights 22, 22′ and back up lights 24, 24′ of the vehicle. Such location provides an even view to both the left rear and right rear of the vehicle 14.

FIG. 6 illustrates in schematic form an embodiment 90 of the present invention in which the viewing device 30 with lens 32 is positioned adjacent the right brake light 20 of the vehicle 14. If desired, the viewing device 30 may be positioned adjacent the left brake light 20′. Such locations provides views that are sharper to either the the right rear or left rear, respectively of the vehicle 14.

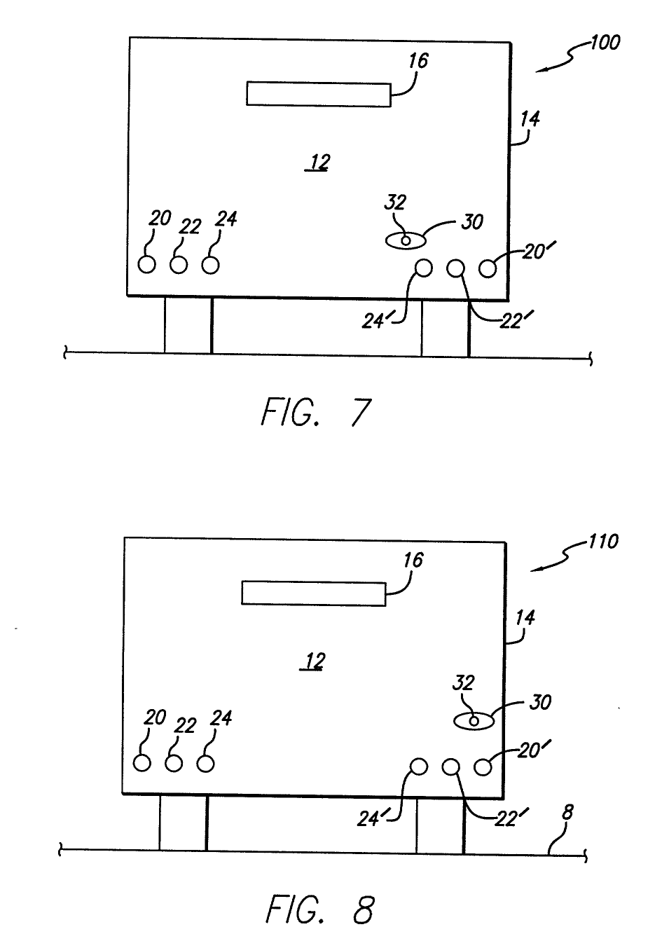

Similarly, in some applications it may be desired to place the viewing device 30 adjacent the back up lights of the vehicle. FIG. 7 illustrates in schematic form an embodiment 100 of the present invention in which the viewing device 30 with lens 32 is positioned adjacent the back up lights 24′, or if desired 24, of the vehicle 14. Such location provides a view more enhanced toward the center of the vehicle 14.

In other applications it may be desired to place the viewing device 30 adjacent the rear or tail lights of the vehicle. FIG. 8 illustrates in schematic form an embodiment 110 of the present invention in which the viewing device 30 with lens 32 is positioned adjacent rear or taillights 22′, or if desired 22, of the vehicle 14

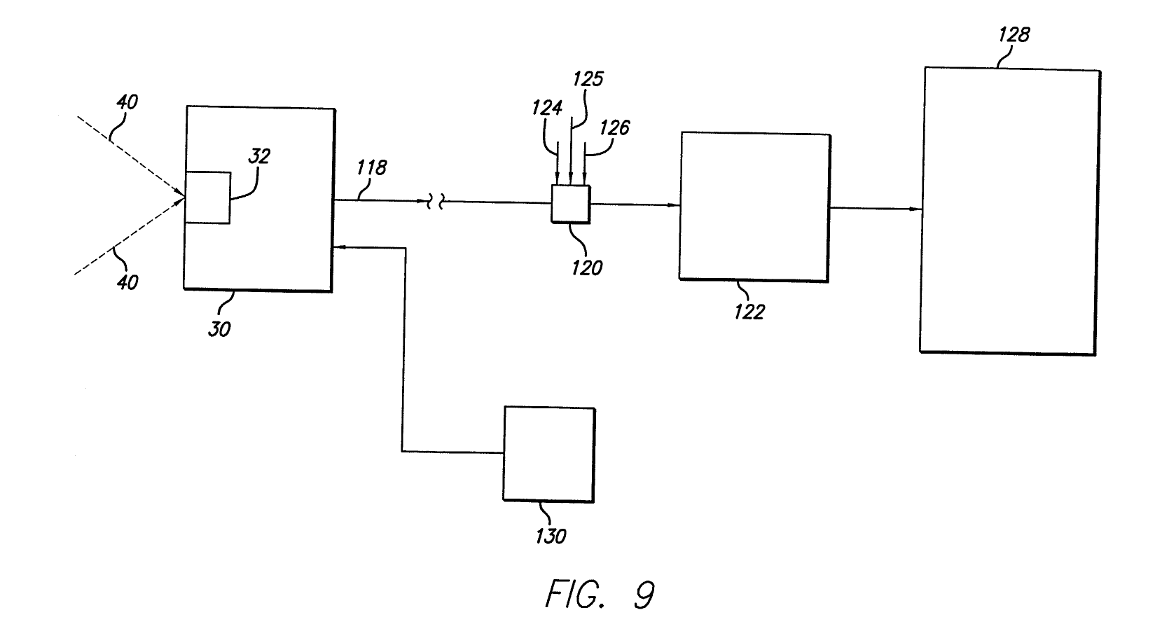

As noted above, the viewing device provides an image of the structure or obstruction to the rear of the vehicle in real time and it is part of the present invention to have the real time view presented or the operator of the vehicle. For passenger vehicles, such as SUV's, sedans, coupes, vans, pick up trucks, 18 wheelers (or other intermediate sized trucks), or the like, the operator of the vehicle is generally located in the forward portion of the body of the vehicle or in the cab at the front of the vehicle. In specialized vehicles, the operator may be located in various other locations on the vehicle. Therefore, the viewing device 30 generates a signal that is indicative of the scene to the rear of the vehicle and this signal is transmitted to a location which is observable by the operator of the vehicle. FIG. 9 illustrates in block diagram form the transmission of the signal from the viewing device to the display source for observation by the operator of the vehicle. As shown on FIG. 9, the viewing device 30 receives the reflected light indicated by the arrows 40 at the lens 32 thereof which is indicative of the scene to the rear of the viewing device 30. The viewing device 30 generates a signal 118 representative of the scene viewed and this signal 118 is connected to a switch means 120, if necessary, as described below, to as signal processor 122 which processes the signal; 18 so that it may provide a real time view of the scene at the rear of the vehicle on the display source which is located in regions observable by the operator of the vehicle. Depending on the type of viewing device 30 and the type of display source 128, such as CRT tube, LED display, TFD display, or the like, the signal processor converts the signal 118 as necessary as is well kn on in the art.

Since some vehicles are now equipped with one or more devices that require a display source, in preferred embodiments of the present invention for such vehicles, the signal 118 is fed through a selector switch 120 which also may receive a GPS signal as indicated at 124, a mapping signal as indicated at 125 and/or other visual display indicia signals as indicated at 126. The selector switch allows selective display of the signals on the display source 128.

As noted above, the viewing device 30 may incorporate many sophisticated features such as pan, focus and the like. These feature are remotely variable by the operator of the vehicle. As shown on FIG. 9, a control 130 is operable by the vehicle operator and controls such features of the viewing device 30.

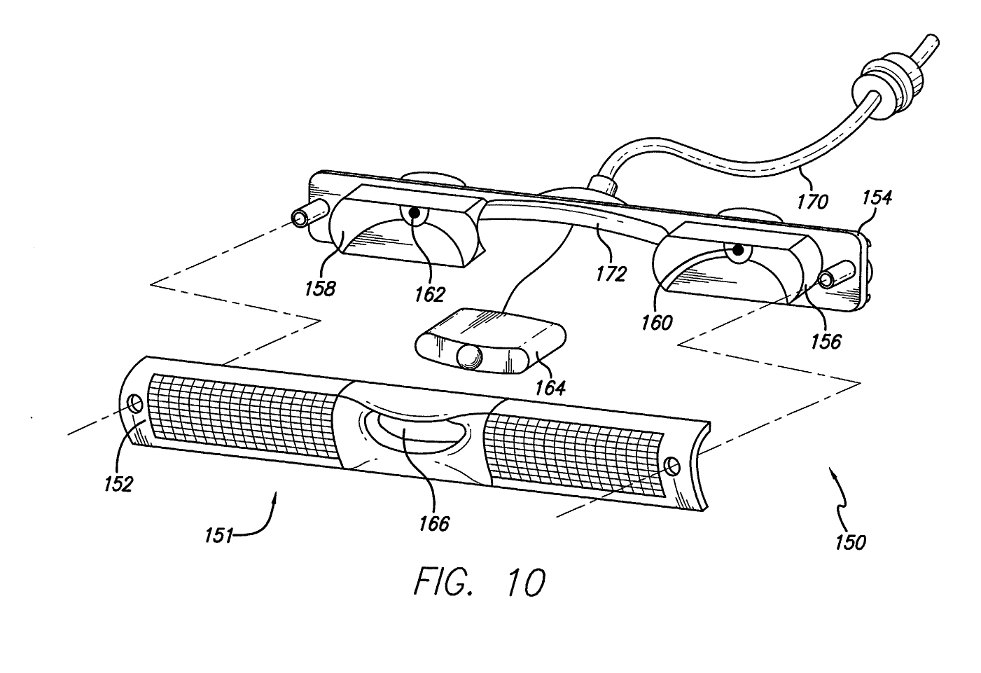

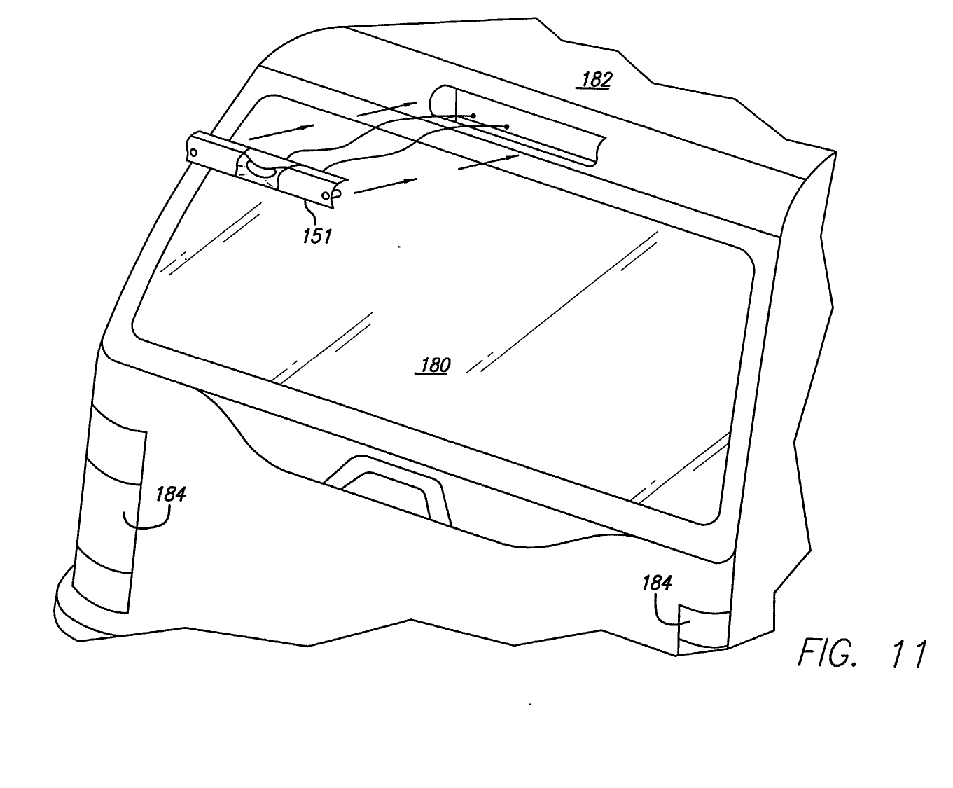

FIG. 10 illustrates an embodiment 150 of an upper brake light assembly for a vehicle and which is generally designated 151 having an outer covering lens 152 which is mounted over a light assembly 154. The light assembly 154 has a pair of spaced apart reflectors 156 and 158 in which light bulbs 160 and 162 are positioned. A viewing device 164 according to the principles of the present invention is centrally located between the two bulbs 160 and 162 and may be oriented to project through an aperture 166 in the covering lens 154, but for prevention of damage, still recessed within the lens 152. The viewing device 164 may be incorporated in any desired case or container as may be desired for particular applications. The viewing device 164 may be powered by electricity through an appropriate cable 170 connected to the electrical system (not shown) of the vehicle and the viewing device 164 transmits the signal generated by the viewing device 164 to the display source, as described above, through the cable 170. A back plate 172 may be incorporated to retain the viewing device 164 in place in the assembly 151. As noted above, the upper brake light assembly 151 may be incorporated in any of the locations where such assembly may be mounted on a vehicle.

FIG. 11 illustrates the mounting of the upper brake light assembly 151 on an SUV or van type vehicle 180 where the upper brake light assembly is located near the top of the roof 182 of the vehicle 180 The vehicle 180 may also be provided with a combination vertical rear light assembly 184 on each side of the vehicle 180. Such an arrangement is often utilized on such vehicles.

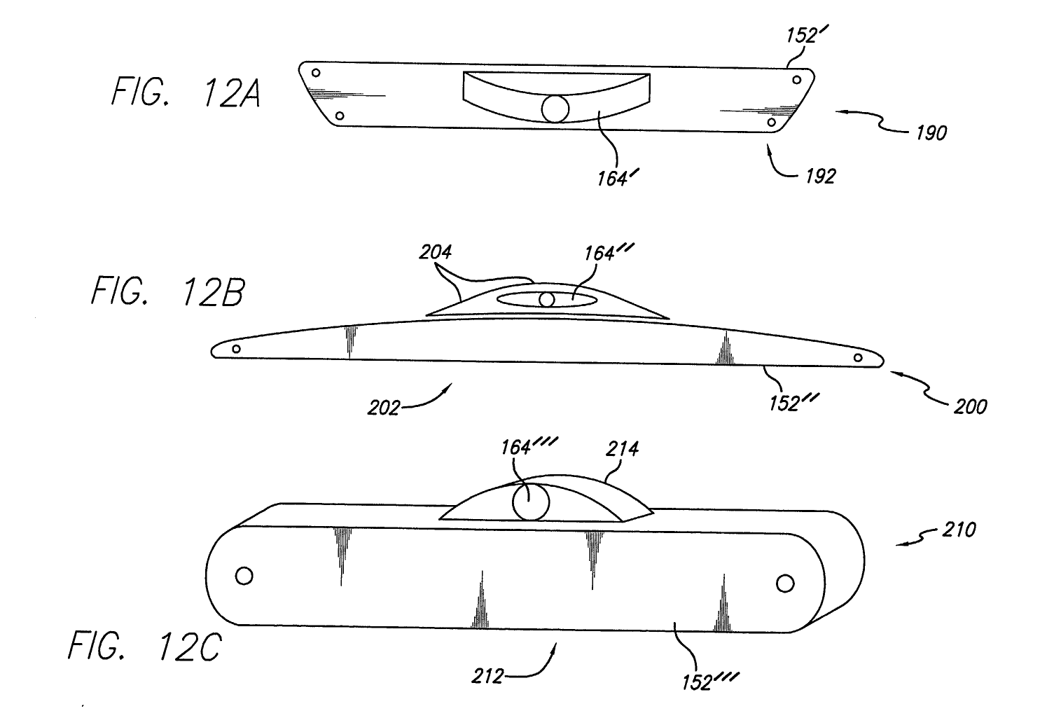

FIG. 12A illustrates a modified embodiment generally designated 190 of an upper brake light assembly 192 incorporating a viewing device 164′ according to the principles of the present invention in which the viewing device 164′ projects outwardly from the covering lens 152. FIG. 12B illustrates a further modified embodiment generally designated 200 of an upper brake light assembly 202 incorporating a viewing device 164″ according to the principles of the present invention in which the viewing dev ice 164″ is mounted in a casing 204 which is located above the covering lens 152″. FIG. 12C illustrates a further modified embodiment generally designated 210 of an upper brake light assembly 212 incorporating a viewing device 164″ according to the principles of the present invention in which the viewing device 164″ is mounted above the covering lens 152″ and in which the covering lens 152″ has a different configuration from the covering lens 152″ or 152′. The viewing device 164″ is mounted in a casing 214 on the upper brake light assembly 212.

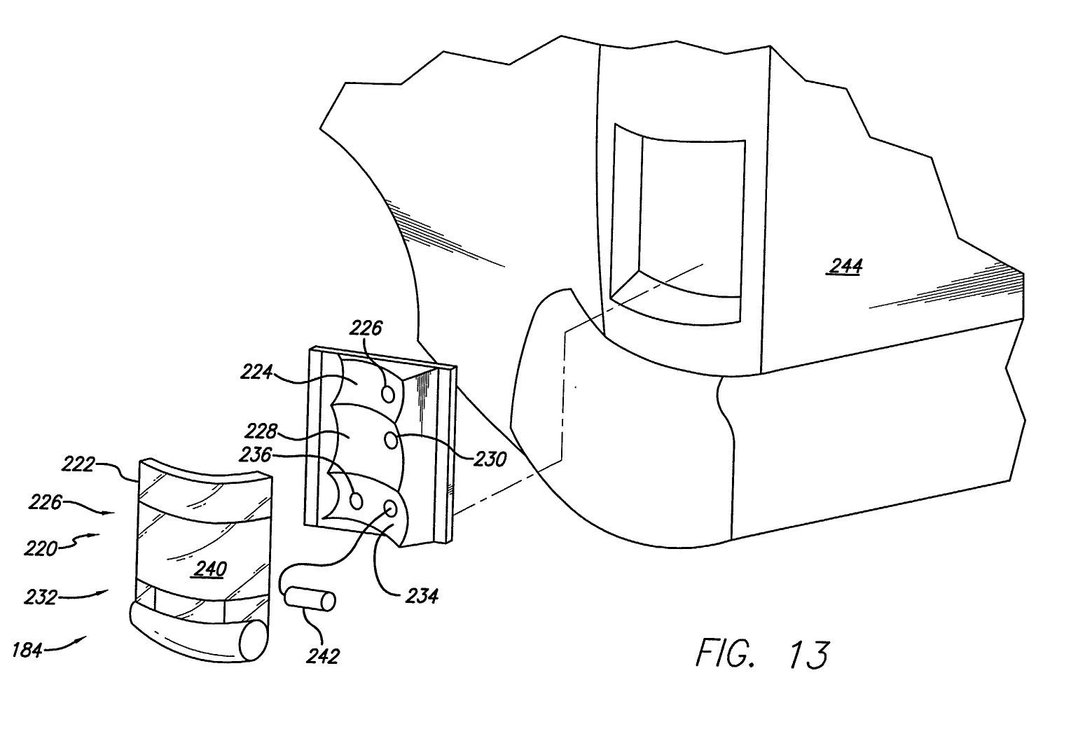

FIG. 13 illustrates an exploded view of an embodiment 220 of the present invention showing the installation in a vertical rear light assembly 184 as shown on FIG. 11. In the rear light assembly 184, there is provided, for example, a lower brake light as indicated at 222 with a reflector 224 and light bulb 226. Similarly, a rear light indicated at 226 has a reflector 228 and a light bulb 230. A back up light indicated at 232 is also provided and has a reflector 234 and light bulb 236. The covering lens 240 may be a unitary lens or may be made up of two or more separate covering lenses. At the bottom of the covering lens 240 there is provided a housing for a viewing device 242 which is positioned therein in an orientation to view the scene to the center of rear of the vehicle 244 through aperture 246 rather than longitudinally to the rear of the vehicle 244 because of the location of the viewing device 242 at the side of the vehicle 244.

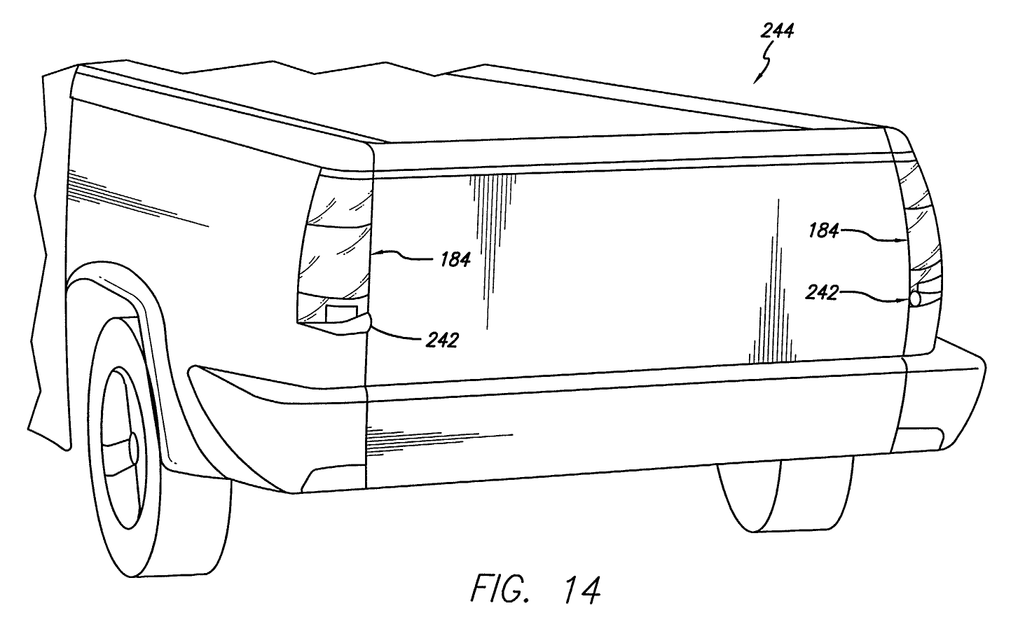

FIG. 14 illustrates a pick up truck generally designated 244′ which is similar to the vehicle 244 and which incorporates the rear light assembly 184 on both sides of the pick up truck 244 and in which a viewing device 242 is incorporated in each rear light assembly 184.

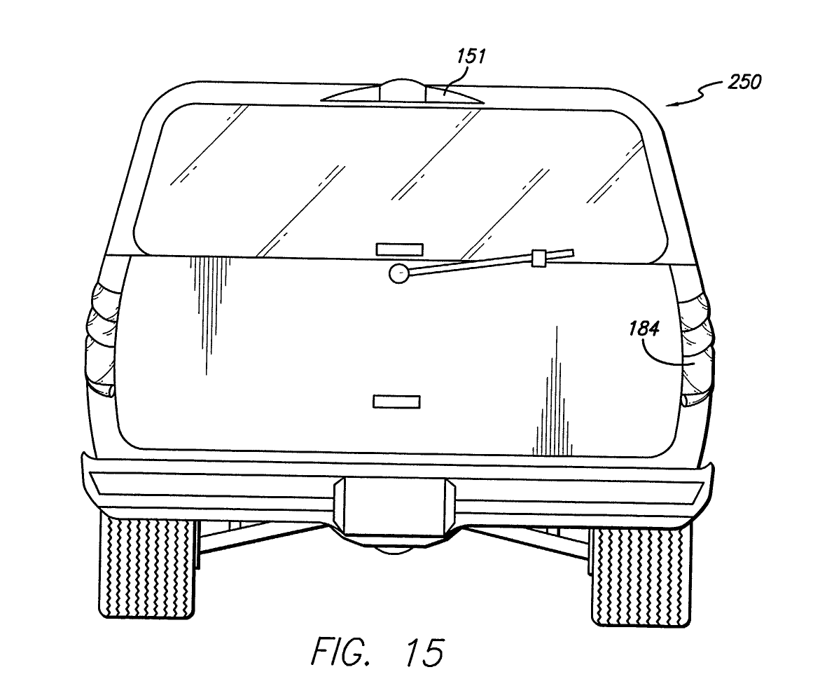

FIG. 15 illustrates the back of an SUV or van type vehicle generally designated 250 which incorporates an upper brake light assembly 151 as illustrated in FIG. 10 and two rear light assemblies 184 as illustrated in FIG. 13. Each of the upper brake light 151 and rear light assemblies 184 have a viewing device 242 or 164 incorporated therein.

In those embodiments of the present invention wherein multiple viewing devices are incorporated, appropriate switching devices at the display source may be incorporated to show alternate views from each of the viewing devices or have a split screen to show all the views simultaneously.

This concludes the description of the present invention. As shown by the preceding description and as illustrated in the accompanying drawing, there has been provided an improved viewing device for a vehicle that allows presentation to the operator of the vehicle a real time view of the structure or lack of structure to the rear of the vehicle and minimizes if not eliminates any dangerous blind spots which are not viewable in rear view mirrors or by turning the head to look to the rear. Those skilled in the art may find many variations and adaptations of the present invention and the following claims are intended to cover all such variations and adaptations falling within the true scope and spirit thereof.

We claim:

1. An improved viewing arrangement for a vehicle for providing a real time image of the scene to the rear of the vehicle and the vehicle controlled by an operator, comprising, in combination:
a vehicle of the type adapted to move along the ground, said vehicle having a front portion and a rear portion and in which the operator of the vehicle is located in regions remote from the rear portion;
at least one light source for emitting electromagnetic radiation in the visual portion of the electromagnetic spectrum into regions spaced rearwardly of the vehicle;
a viewing device arrangement comprising at least one viewing device on the vehicle in reflected light receiving relationship to an object to the rear of said vehicle and said viewing device for generating a signal indicative of the scene to the rear of the vehicle;
and said viewing device in close proximity to said at least one light source.
a display source on said vehicle in regions viewable by the operator of said vehicle for receiving said signal generated by said viewing device and providing a visual display indicative of the scene to the rear of the vehicle.

2. The arrangement defined in claim 1 wherein:
said at least one light source comprises the upper brake light of said vehicle.

3. The arrangement defined in claim 2 wherein: said viewing device comprises a camera and said camera has a lens for receiving said reflected light.

4. The arrangement defined in claim 3 wherein:
said camera comprises a digital camera.

5. The arrangement defined in claim 4 wherein:
said display source is a CRT.

6. The arrangement defined in claim 4 wherein:
said display source comprises an LED display.

7. The arrangement defined in claim 4 wherein:
said display source comprises a CRT and further comprising:
a signal processor for receiving said signal generated by said digital camera and converting said signal to a signal compatible with said display source to provide said visual display of said scene to the rear of the vehicle thereon.

8. The arrangement defined in claim 7 wherein said vehicle is adapted to receive a plurality of signals for displaying a plurality of visual displays on said display source and further comprising:
a selector switch for receiving said plurality of signals and said signal generated by said viewing device and selectively allowing the sequential transmission of one of said signals to said signal processor.

9. The arrangement defined in claim 1 wherein said vehicle has a plurality of light sources on said rear portion thereof, and said plurality of light sources comprises at least one rear or tail light, at least one lower brake light, at least one upper brake light and at least one back up light for emitting electromagnetic radiation in the visual portion of the electromagnetic spectrum to regions spaced to the rear of the vehicle and in which said viewing device is located in regions adjacent to one of said plurality of light sources in reflected light receiving relationship to structure or obstruction to the rear of said vehicle for receiving light reflected from such structure or obstruction spaced from the rear of said vehicle, whereby a real time view of the structure or obstruction is provided on said display source.

10. The arrangement defined in claim 9 wherein:
said viewing device is located in regions adjacent said upper brake light.

11. The arrangement defined in claim 9 wherein:
said viewing device is incorporated into said upper brake light.

12. The arrangement defined in claim 9 wherein:
said viewing device is located in regions adjacent said at least one rear or tail light.

13. The arrangement defined in claim 9 wherein:
said viewing device is located in regions adjacent said at least one lower brake light.

14. The arrangement defined in claim 9 wherein:
said viewing device is located in regions adjacent said at least one back up light.

15. The arrangement defined in claim 9 wherein:
said vehicle comprises a pair of spaced apart rear or tail lights, a pair of spaced apart lower brake lights and a pair of spaced apart back up lights, and one of said lower brake lights, one of said rear or tail lights and one of said back up lights are located in regions of the lower left of said rear portion of said vehicle, and the other of lower brake lights and the other of said rear or tail lights and the other of said back up lights is located in regions adjacent the lower right of said rear portion of said vehicle, and said viewing device is located in regions substantially in the middle of said rear portion of said vehicle.

16. The arrangement defined in claim 9 wherein:
said vehicle comprises a pair of spaced apart rear or tail lights, a pair of spaced apart lower brake lights and a pair of spaced apart back up lights, and one of said lower brake lights, one of said rear or tail lights and one of said back up lights are located in regions of the lower left of said rear portion of said vehicle, and the other of lower brake lights and the other of said rear or tail lights and the other of said back up lights is located in regions adjacent the lower right of said rear portion of said vehicle, and said viewing device is located in regions adjacent said upper brake light.

17. The arrangement defined in claim 9 wherein:
said vehicle comprises a pair of spaced apart rear or tail lights, a pair of spaced apart lower brake lights and a pair of spaced apart back up lights, and one of said lower brake lights, one of said rear or tail lights and one of said back up lights are located in regions of the lower left of said rear portion of said vehicle, and the other of lower brake lights and the other of said rear or tail lights and the other of said back up lights is located ill regions adjacent the lower right of said rear portion of said vehicle, and said viewing device is incorporated into said upper brake light.

18. The arrangement defined in claim 17 wherein:
said display source comprises a CRT and further comprising:
a signal processor for receiving said signal generated by said digital camera and converting said signal to a signal compatible with said display source to provide said visual display of said scene to the rear of the vehicle thereon.
